(19) United States
(12) Patent Application Publication
(10) Pub. No.: US 2021/0071284 A1
(43) Pub. Date: Mar. 11, 2021

(54) METHOD FOR HYDROMETALLURGICAL PROCESSING OF A NOBLE METAL-TIN ALLOY

(71) Applicant: Heraeus Deutschland GmbH & Co. KG, Hanau (DE)

(72) Inventor: Christoph Röhlich, Hanau (DE)

(21) Appl. No.: 16/963,661

(22) PCT Filed: Jul. 30, 2018
(86) PCT No.: PCT/EP2018/070531

§ 371 Date: Jul. 21, 2020

(30) Foreign Application Priority Data
Feb. 9, 2018 (EP) 18155948.5

(51) Int. Cl. C22C 13/00; C22C 5/04; C22C 9/00; C22C 5/08; C22C 1/02; C22C 3/00

(52) U.S. Cl. CPC C22C 13/00; C22C 5/04; C22C 3/005; C22C 5/08; C22C 1/02; C22C 9/00

(57) ABSTRACT

A method for the hydrometallurgical processing of a noble metal-tin alloy consisting of (i) 0.45 to 25% by weight of at least one metal A selected from the group consisting of gold and platinum, (ii), 35 to 99.2% by weight of at least one metal B selected from the group consisting of palladium, silver, and copper, (iii) 0.3 to 30% by weight tin, and (iv) 0 to 50% by weight of at least one element other than gold, platinum, palladium, silver, copper, and tin, and has a weight ratio of metal A:tin of ≥0.7:1, comprising the steps of:

(a1) specifically selecting a noble metal-tin alloy
or
(a2) specifically producing a noble metal-tin alloy;
(b) dissolving nitric acid-soluble components of the noble metal-tin alloy with nitric acid while forming a nitric acid-containing solution comprising the at least one metal B in the form of the dissolved nitrate, and an undissolved residue;
(c) separating the undissolved residue from the nitric acid-containing solution; and
(d) dissolving the separated residue in a medium that comprises hydrochloric acid and at least one oxidation agent.

The invention relates to a process for hydrometallurgical processing of certain alloys that consist of (i) gold and/or platinum, (ii) palladium, silver and/or copper, (iii) tin and, if applicable, (iv) one or more other element(s) and have a certain weight ratio of gold and/or platinum:tin.

Gold, platinum, palladium, and silver are precious metals, whereas copper and tin are base metals.

Alloys that contain gold and/or platinum, on the one hand, and palladium, silver and/or copper, on the other hand, for example gold-silver alloys such as, for example, Dore metal, are usually processed by hydrometallurgical technique by first treating them with nitric acid in a first step, whereby the metals palladium, silver and/or copper, which are less noble than gold and platinum, are dissolved in the form of nitrates. Gold and/or platinum in the remaining residue can be dissolved in a subsequent step in the form of tetrachloroauric acid and/or hexachloroplatinic acid using a medium that comprises hydrochloric acid and suitable oxidation agent. If said alloys also contain tin, it is often not possible to readily carry out this separation step. Presumably, the tin contacting the nitric acid during the first step is turned into voluminous, extremely fine-particulate tin dioxide, which, due to its often gel-like nature, makes the further procedure of the separation process, in particular the steps of the solid-liquid separation, much more difficult. The residue formed in this process, which comprises gold and/or platinum and is associated with the tin dioxide, requires an additional separation step, for example a pyrometallurgical separation step.

The applicant determined that the difficulties described above can be prevented, surprisingly, as soon as the above-mentioned precious metal-tin alloys comprise, in particular, a certain weight ratio of gold and/or platinum:tin. Presumably in these cases, rather than tin dioxide, an alloy that comprises tin as well as gold and/or platinum is formed that cannot be attacked by nitric acid alone, but can be dissolved in the subsequent step using the medium comprising hydrochloric acid and suitable oxidation agent while forming hexachlorostannic acid as well as tetrachloroauric acid and/or hexachloroplatinic acid.

The invention relates to a process for hydrometallurgical processing of a precious metal-tin alloy consisting of (i) 0.45 to 25% by weight of at least one metal A selected from the group consisting of gold and platinum, (ii), 35 to 99.2% by weight of at least one metal B selected from the group consisting of palladium, silver, and copper, (iii) 0.3 to 30% by weight tin, and (iv) 0 to 50% by weight of at least one element other than gold, platinum, palladium, silver, copper, and tin, that has a weight ratio of metal A:tin of 0.7:1, preferably in the range of 1:1 to 10:1. The process comprises the steps of:

(a1) specifically selecting a precious metal-tin alloy
or
(a2) specifically producing a precious metal-tin alloy;
(B) dissolving nitric acid-soluble components of the precious metal-tin alloy with nitric acid while forming a nitric acid-containing solution comprising the at least one metal B in the form of the dissolved nitrate, and an undissolved residue;
(c) separating the undissolved residue from the nitric acid-containing solution; and
(d) dissolving the separated residue in a medium that comprises hydrochloric acid and at least one oxidation agent.

It is essential to the invention that the precious metal-tin alloy is specifically selected in process step (a1) or is specifically produced in process step (a2) such that it is composed of the components, (i) 0.45 to 25% by weight, preferably 3 to 20% by weight, of at least one metal A selected from the group consisting of gold and platinum, (ii), 35 to 99.2% by weight, preferably 40 to 95% by weight, of at least one metal B selected from the group consisting of palladium, silver, and copper, (iii) 0.3 to 30% by weight, preferably 2 to 17.5% by weight, tin, and (iv) 0 to 50% by weight of at least one element other than gold, platinum, palladium, silver, copper, and tin, such as to add up to 100% by weight, that concurrently has a weight ratio of metal A:tin of 0.7:1, preferably in the range of 1:1 to 10:1. It is obvious to a person skilled in the art that the weight ratio of metal A:tin cannot assume values >83.3:1 due to the weight-quantitative ratios of components (i) to (iv).

Preferably, the precious metal-tin alloy consists of (i) 3 to 20% by weight of at least one metal A selected from the group consisting of gold and platinum, (ii), 40 to 95% by weight of at least one metal B selected from the group consisting of palladium, silver, and copper, (iii) 2 to 17.5% by weight tin, and (iv) 0 to 50% by weight of at least one element other than gold, platinum, palladium, silver, copper, and tin, that has a weight ratio of metal A:tin in the range of 1:1 to 10:1.

Precious metal-tin alloys with the aforementioned composition are precious metal-tin alloys with a composition as is essential to the invention, which hereinafter shall also be for referred to as “precious metal-tin alloys of the type with a composition as is essential to the invention” or as “the precious metal-tin alloy”. Obviously, the composition of the precious metal-tin alloy that is essential to the invention is an essential prerequisite for successful and trouble-free implementation of the process according to the invention while preventing the earlier-mentioned problems during solid-liquid separation.

In the embodiment of the process according to the invention that comprises process step (a1), the precious metal-tin alloy is selected specifically, in particular from precious metal-tin alloys. The specific selection is made such that the aforementioned conditions concerning the composition and, concurrently, the weight ratio of metal A:tin, which are essential to the invention, are met. Accordingly, the precious metal-tin alloy of the type with a composition as is essential to the invention can already be available and be ready for use and can be processed by hydrometallurgical technique in process steps (b) to (d).

In contrast, in the embodiment of the process according to the invention comprising process step (a2), the precious metal-tin alloy is initially produced specifically such that the aforementioned conditions, i.e. composition and corresponding weight ratio of metal A:tin, that are essential to the invention, are met. In this context, it is obvious that the precious metal-tin alloy can be produced by alloying the metals and/or elements from which it is made. However, it is evident to a person skilled in the art from the overall context of the present patent application that the precious metal-tin alloy is generally preferred to not be produced by alloying the metals and/or elements from which it is made. Rather, the precious metal-tin alloy can be produced specifically in process step (a2) according to any one of the following procedures (a2-1) to (a2-5), which are known to a person skilled in the art. A person skilled in the art knows, in the individual case, how to expediently select and combine the type and amount of the starting materials in order to attain a precious metal-tin alloy of the type as is essential to the invention.

Procedure (a2-1) comprises or consists of melting at least one recyclable material to be recycled while forming a multi-phase system comprising a lower phase made of molten precious metal-tin alloy of the type with a composition as is essential to the invention, and an upper phase made of molten slag having a lower density, if applicable while adding collecting metal and/or slag forming agent and/or reducing agent, and separating the upper phase from the lower phase making use of the difference in density, followed by cooling the separated molten materials and allowing them to solidify, and obtaining the solidified precious metal-tin alloy.

This is a pyrometallurgical process during which slag is formed and which can be implemented in a so-called smelter.

The material to be recycled can be a single material or a mixture of different materials. The at least one material to be recycled can also contain, aside from precious metal and base metal, a substance different from them, the latter being selected, in particular, from inorganic or refractory materials, i.e. inorganic non-metallic materials that are basically not changed physically and chemically at high temperatures, for example, in the range of 200 to 650° C. Examples of inorganic refractory materials comprise silicon dioxide, aluminium oxide, calcium oxide, iron oxide, calcium sulfate, calcium phosphate, and tin dioxide. The at least one substance that is different from precious metal and base metal can be or can have been, for example, a component, the sole component if applicable, of ceramic filter materials, abrasives, polishing agents and/or inorganic carrier materials, for example catalyst carrier materials.

The at least one material to be recycled can originate from one or more different source(s). This can concern mining concentrate and/or one or more waste materials or mixtures of waste materials. Examples of types of waste comprise waste from jewellery production, waste from dentistry, electronics scrap, precious metal scrap, precious metal-containing scrap from precious metal-processing operations, precious metal sweepings, spent precious metal catalysts, precious metal catalyst dusts, precious metal-containing slag, precious metal dross, precious metal-containing and possibly dried sludge, for example from electro-refining processes, and overburden from precious metal mines.

Procedure (a2-2) comprises or consists of treating a molten alloy that is different from the precious metal-tin alloy of the type with a composition as is essential to the invention, with an oxidation agent, such as, in particular, oxygen, while forming a multi-phase system comprising a lower phase made of molten precious metal-tin alloy of the type with a composition as is essential to the invention, and an upper phase made of molten slag having a lower density, in which the oxidation products produced are present, if applicable while adding collecting metal and/or slag forming agent, and separating the upper phase from the lower phase making use of the difference in density, followed by cooling the separated molten materials and allowing them to solidify, and obtaining the solidified precious metal-tin alloy.

This is a pyrometallurgical process during which slag is formed and which can be implemented, e.g., in a so-called converter.

Procedure (a2-3) comprises or consists of alloying at least two alloys that are different from each other, possibly while adding into the alloy at least one element, for example a metal, while forming a precious metal-tin alloy of the type with a composition as is essential to the invention. The at least two alloys that are different from each other can be at least two precious metal-tin alloys of the type with a composition as is essential to the invention that are different from each other, or at least two precious metal-tin alloys that are different from each other and are different from the type with a composition as is essential to the invention, or at least one precious metal-tin alloy of the type with a composition as is essential to the invention and at least one precious metal-tin alloy that is different from the type with a composition as is essential to the invention. In general, at least one of the at least two alloys that are different from each other is not a precious metal-tin alloy of the type with a composition as is essential to the invention. Frequently, none of the at least two alloys that are different from each other is a precious metal-tin alloy of the type with a composition as is essential to the invention.

Procedure (a2-4) comprises or consists of alloying at least one element, for example one metal, into an alloy while forming a precious metal-tin alloy of the type with a composition as is essential to the invention. The alloy to which the element is alloyed can be a precious metal-tin alloy of the type with a composition as is essential to the invention; but will, in general, not be a precious metal-tin alloy of the type with a composition as is essential to the invention.

Procedure (a2-5) comprises or consists of removing tin by distillation, for example an excess of tin, from an alloy, if applicable supported by a vacuum and/or reduced pressure while forming a precious metal-tin alloy of the type as essential to the invention. The alloy from which the tin is removed by distillation can be a precious metal-tin alloy of the type with a composition as is essential to the invention; but will, in general, not be a precious metal-tin alloy of the type with a composition as is essential to the invention.

Procedures (a2-2) to (a2-5) need not be illustrated any further, since a person skilled in the art is aware of their underlying process principles.

In step (b) of the process according to the invention, nitric acid-soluble and/or the nitric acid-soluble components of the precious metal-tin alloy that is specifically selected in step (a1) or is specifically produced in step (a2) are dissolved using nitric acid while forming a nitric acid-containing solution comprising the at least one metal B as dissolved nitrate and an undissolved residue.

The nitric acid used in step (b) has an oxidising effect and its concentration is, for example, in the range of 10 to 67% by weight.

Step (b) can be carried out at temperatures, for example, in the range of 20° C. to boiling temperature.

Obviously, the aforementioned formation of voluminous, fine-particulate, and, if applicable, gel-like tin dioxide does not only take place initially. The undissolved residue comprising gold and/or platinum does not require an additional chemical treatment or separation step before process step (d) is carried out. Obviously, the undissolved residue is not associated with interfering tin dioxide and/or at least essentially does not comprise the same or is free thereof.

In step (c) of the process according to the invention, the undissolved residue formed in step (b) is separated from the nitric acid-containing solution. Conventional solid-liquid separation procedures known to a person skilled in the art can be used in this context, for example decanting, lifting, filtration or suitable combinations of said separation procedures.

As mentioned before, the residue separated in step (c) does not require an additional chemical treatment or separation step before process step (d) is carried out.

In step (d) of the process according to the invention, the undissolved residue separated from the nitric acid-containing solution in step (c) is dissolved in a medium comprising hydrochloric acid and at least one oxidation agent. Depending on the at least one metal A of the precious metal-tin alloy, a solution comprising hexachlorostannic acid and tetrachloroauric acid or hexachlorostannic acid and hexachloroplatinic acid or hexachlorostannic acid and tetrachloroauric acid and hexachloroplatinic acid may be produced.

The hydrochloric acid used in step (d) has a concentration, for example, in the range of 3 to 12 mol/L.

The at least one oxidation agent can be selected, in particular, from the group consisting of nitric acid, chlorates, nitrates, bromates, iodates, chlorites, bromites, iodites, hypochlorites, hypobromites, hypoiodites, perchlorates, ozone, ozonides, superoxides, oxygen, chlorine, bromine, iodine, peroxo compounds, permanganates, and chromates.

Step (d) can be carried out at temperatures, for example, in the range of 20° C. to boiling temperature.

### EXAMPLES

### Inventive Examples 1-6

A total of 4 mL nitric acid (53% by weight) per gram of alloy were added to each of the alloys of the compositions specified in the table below and the batch was heated carefully from room temperature to 100° C. while stirring. The alloys dissolved partially in this context while forming a residue with a black to metallic gloss and NOx gas. The cessation of the production of NOx signaled the end of the dissolution reaction (duration between 2 and 7 hours). After cooling, it was possible to filter the mixture obtained in each case within a period of 10 to 60 minutes and it was possible to wash the residue repeatedly with water.

Aqua regia (a mixture of 75 mL 10M hydrochloric acid and 25 mL nitric acid (53% by weight nitric)) or 6M hydrochloric acid was added to the washed residue and the total volume was adjusted to 100 mL. The mixture was heated to 80° C. while stirring and, unless this had already been done, nitric acid (53% by weight) was added until no change in the reaction mixture and no further formation of NOx was observed upon further addition (10 to 20 mL of the nitric acid (53% by weight)). The residue dissolved while forming a yellow to orange, clear solution. After cooling, it was possible to filter the mixture obtained in each case within a period of 10 to 60 minutes and it was possible to wash the residue with 6M hydrochloric acid.

| | | | | | | | Weight |
|---|---|---|---|---|---|---|---|
| | | wt. % | | | | | ratio |
| Exam- | Gram | | Metal A | | | Other | Au + |
| ple | alloy | Metal B | Au | Pt | Sn | elements | Pt:Sn |
| 1 | 15.41 | Ag 56.1 | 16.2 | 1.24 | 15.6 | Zn 3.3 | 1.12:1 |
| | | Cu 11.6 | | | | Fe 1.0 | |
| | | Pd 3.74 | | | | Ni 0.4 | |
| | | | | | | Co 0.6 | |
| 2 | 12.36 | Ag 32.1 | 6.7 | 0.45 | 9.85 | Zn 0.5 | 0.73:1 |
| | | Cu 9.0 | | | | Fe 4.9 | |
| | | Pd 1.3 | | | | | |
| 3 | 15.33 | Ag 44.3 | 17.2 | 1.36 | 14.5 | Zn 3.0 | 1.28:1 |
| | | Cu 9.8 | | | | Ni 0.6 | |
| | | Pd 3.9 | | | | Fe 0.2 | |
| 4 | 23.00 | Ag 55 | 14.5 | 1.25 | 7.9 | Co 0.7 | 1.99:1 |
| | | Cu 10.2 | | | | Fe 0.6 | |
| | | Pd 3.9 | | | | Ni 0.6 | |
| | | | | | | Zn 0.6 | |
| 5 | 9.08 | Ag 34.2 | 10.6 | 0.97 | 5.8 | Zn 0.47 | 1.99:1 |
| | | Cu 43.26 | | | | Ni 0.4 | |
| | | Pd 2.72 | | | | | |
| 6 | 9.36 | Ag 54.97 | 16.36 | 1.45 | 5.96 | Zn 0.49 | 2.99:1 |
| | | Cu 10.0 | | | | Ni 0.46 | |
| | | Pd 4.23 | | | | Fe 0.1 | |
| | | | | | | Co 0.1 | |

### Reference Examples 7 to 9

A total of 4 mL nitric acid (53% by weight) per gram of alloy were added to each of the alloys of the compositions specified in the table below and the batch was heated carefully from room temperature to 100° C. while stirring. The alloys dissolved partially in this context while forming a purple voluminous residue and NOx gas. The cessation of the production of NOx signaled the end of the dissolution reaction (duration between 2 and 7 hours). After cooling, it was possible to filter the mixture obtained in each case within a period of 10 to 60 minutes and it was possible to wash the residue repeatedly with water.

The purple colour of the residue indicated the production of Au particles in tin dioxide matrix (“purple of Cassius”). A phase analysis on a sample of the residue done by x-ray diffractometry showed tin dioxide to be the main phase.

The washed residue was filled up with 6M hydrochloric acid to 200 mL, heated to 80° while stirring, and either 4.5 M sodium chlorate solution or nitric acid (53% by weight) were added in drops until the redox potential of the mixture was >900 mV vs. Ag/AgCl standard electrode. In the process, the mixture changed colour from purple to yellow, and a milky suspension was produced.

The mixture was allowed to cool down and was then filtered through a blue band paper filter. A clear filtrate was obtained in no case in this context, since fine white particles passed through the filter. The filtration proceeded slowly and could be done in no case within a period of time of less than 6 hours. In some cases, the mixture formed a stable suspension of a gel-like to slimy consistency that clogged the filter and made solid/liquid separation impossible.

| | | | | | | | Weight |
|---|---|---|---|---|---|---|---|
| | | wt. % | | | | | ratio |
| Exam- | Gram | | Metal A | | | Other | Au + |
| ple | alloy | Metal B | Au | Pt | Sn | elements | Pt: Sn |
| 7 | 125.6 | Ag 50 | 1.2 | 0.11 | 26 | Pb 1.7 | 0.05:1 |
| | | Cu 17 | | | | Bi 2.4 | |
| | | Pd 0.45 | | | | Ni 0.14 | |
| | | | | | | Fe 0.3 | |
| 8 | 89.05 | Ag 47.5 | 3.0 | 0.25 | 26 | Pb 1.5 | 0.125:1 |
| | | Cu 16 | | | | Bi 2.0 | |
| | | Pd 0.9 | | | | Zn 1.0 | |
| | | | | | | Co 0.3 | |
| | | | | | | Ni 0.2 | |
| | | | | | | Fe 0.5 | |
| 9 | 67.98 | Ag 64 | 4.4 | 0.3 | 7.7 | Pb 0.66 | 0.61:1 |
| | | Cu 18 | | | | | |
| | | Pd 1.2 | | | | | |

### Reference Example 10

A metal button with a composition of 18 wt. % Cu, 26 wt. % Sn, 49 wt. % Ag, 0.7 wt. % Au, 0.35 wt. % Pd, 1.7 wt. % Pb, 2.4 wt. % Bi, 1 wt. % Zn, 0.3 wt. % Fe, 0.13 wt. % Ni, 0.12 wt. % Co; weight ratio of Au:Sn=0.027:1 was used.

The metal button was divided and a fragment of approximately 10 g each was placed in a beaker and 4 mL nitric acid (53% by weight) per gram of alloy were poured over it, and this was diluted with water to obtain ¾- and ½-concentrated nitric acid:

| | | | | | | |
|---|---|---|---|---|---|---|
| Metal | 9.91 | g | 9.44 | g | 9.53 | g |
| Nitric acid | 40 | ml | 40 | ml | 40 | ml |
| Water | 0 | ml | 40 | ml | 13.3 | ml |

| | | | |
|---|---|---|---|
| Nitric acid | concentrated | ½-concentrated | ¾-concentrated |
| concentration | | | |

A vigorous dissolution reaction commenced immediately. After 5 hours at room temperature, a green solution had formed. This was heated to 100° C. while stirring for 4 hours. The metal button fragment disintegrated in each case and a purple-red suspension was formed; in some cases, a white precipitate was visible.

The mixture was stirred overnight at room temperature, then for another 3 hours at 100° C. Initially, some reaction was observed to proceed after heating, but ceased later on. The sample was allowed to cool down while stirring it. The supernatant solution was filtered through a blue band filter.

The residues were placed in a beaker right away and the beaker was filled up to approximately 100 mL with 6M hydrochloric acid. Droplets of 4.5M sodium chlorate solution were added at 60° C. while stirring. Once 0.2 mL had been added, the mixture changed colour from purple to milky yellow in each case. A total of 1 mL sodium chlorate solution was added in each case. The sample was stirred for 1.5 hours, then the excess chlorate was boiled off and the solution was allowed to cool down. The mixtures were filtered, upon which a white precipitate was observed again in each case, with the precipitate being so fine that it penetrated through the filter.

1. A process for hydrometallurgical processing of a precious metal-tin alloy consisting of (i) 0.45 to 25% by weight of at least one metal A selected from the group consisting of gold and platinum, (ii), 35 to 99.2% by weight of at least one metal B selected from the group consisting of palladium, silver, and copper, (iii) 0.3 to 30% by weight of tin, and (iv) 0 to 50% by weight of at least one element other than gold, platinum, palladium, silver, copper, and tin, and has a weight ratio of metal A:tin of greater than 0.7:1, comprising the steps of:
(a1) specifically selecting a precious metal-tin alloy or (a2) specifically producing a precious metal-tin alloy;
(b) dissolving nitric acid-soluble components of the precious metal-tin alloy with nitric acid while forming a nitric acid-containing solution comprising the at least one metal B in the form of a dissolved nitrate, and an undissolved residue;
(c) separating the undissolved residue from the nitric acid-containing solution; and
(d) dissolving the separated undissolved residue in a medium that comprises hydrochloric acid and at least one oxidation agent.

2. The process of claim 1, wherein the precious metal-tin alloy consists of (i) 3 to 20% by weight of the at least one metal A, (ii), 40 to 95% by weight of the at least one metal B, (iii) 2 to 17.5% by weight of tin, and (iv) 0 to 50% by weight of the at least one element other than gold, platinum, palladium, silver, copper, and tin, and the weight ratio of metal A:tin is in the range of 1:1 to 10:1.

3. The process of claim 1, wherein step (a2) is selected from one of procedures (a2-1)-(a2-5), wherein
procedure (a2-1) comprises melting at least one recyclable material to be recycled while forming a multi-phase system comprising a lower phase made of the molten precious metal-tin alloy of the type, and an upper phase made of molten slag having a lower density, if applicable while adding collecting metal and/or slag forming agent and/or reducing agent, and separating the upper phase from the lower phase making use of the difference in density, followed by cooling the separated molten materials and allowing them to solidify, and obtaining the solidified precious metal-tin alloy;
procedure (a2-2) comprises treating a molten alloy that is different from the precious metal-tin alloy with an oxidation agent while forming a multi-phase system comprising a lower phase made of the molten precious metal-tin alloy and an upper phase made of molten slag having a lower density, in which the oxidation products produced are present, if applicable while adding collecting metal and/or slag forming agent, and separating the upper phase from the lower phase making use of the difference in density, followed by cooling the separated molten materials and allowing them to solidify, and obtaining the solidified precious metal-tin alloy;
procedure (a2-3) comprises alloying at least two alloys that are different from each other, possibly while adding into the alloy at least one element while forming the precious metal-tin alloy;
procedure (a2-4) comprises alloying at least one element into an alloy while forming the precious metal-tin alloy; and
procedure (a2-5) comprises removing tin by distillation from an alloy while forming the precious metal-tin alloy.

4. The process of claim 3, whereby the at least one recyclable material to be recycled contains, aside from precious metal and base metal, at least one substance that is not a precious metal and not a base metal.

5. The process of claim 4, whereby the at least one substance that is not a precious metal and not a base metal is selected from the group of inorganic refractory materials.

6. The process of claim 5, whereby the group of inorganic refractory materials consists of silicon dioxide, aluminium oxide, calcium oxide, iron oxide, calcium sulfate, calcium phosphate, and tin dioxide.

7. The process of claim 4, whereby the at least one substance that is not a precious metal and not a base metal is a component of ceramic filter materials, abrasives, polishing agents and/or inorganic carrier materials.

8. The process of claim 3, whereby the at least one recyclable material to be recycled is selected from the group consisting of mining concentrates, waste and mixed waste, whereby the waste is selected from the group consisting of waste from jewellery production, waste from dentistry, electronics scrap, precious metal scrap, precious metal-containing scrap from precious metal-processing operations, precious metal sweepings, spent precious metal catalysts, precious metal catalyst dusts, precious metal-containing slag, precious metal dross, precious metal-containing and possibly dried sludge, and overburden from precious metal mines.

9. The process of claim 1, whereby the concentration of the nitric acid used in step (b) is in the range of 10 wt % to 67 wt. %.

10. The process of claim 1, whereby the concentration of the hydrochloric acid used in step (d) is in the range of 3 mol/L to 12 mol/L.

11. The process of claim 1, whereby the at least one oxidation agent used in step (d) is selected from the group consisting of nitric acid, chlorates, nitrates, bromates, iodates, chlorites, bromites, iodites, hypochlorites, hypobromites, hypoiodites, perchlorates, ozone, ozonides, superoxides, oxygen, chlorine, bromine, iodine, peroxo compounds, permanganates, and chromates.
